(19) United States
(12) Patent Application Publication
(10) Pub. No.: US 2014/0025436 A1
(43) Pub. Date: Jan. 23, 2014

(54) SYSTEM AND METHOD FOR MANAGING ORGANIZATIONAL PARTICIPATION IN OBJECTIVE PURSUITS

(71) Applicant: Subhash DHAR, Palo Alto, CA (US)

(72) Inventor: Subhash DHAR, Palo Alto, CA (US)

(21) Appl. No.: 13/609,899

(22) Filed: Sep. 11, 2012

Related U.S. Application Data
(60) Provisional application No. 61/672,470, filed on Jul. 17, 2012.
(60) Provisional application No. 61/696,183, filed on Sep. 2, 2012.

(51) Int. Cl. G06Q 10/06

(52) U.S. Cl. 705/7.36

(57) ABSTRACT

In one embodiment, is provided a system for managing organizational participation in an objective pursuit. The system comprises a first local computer operated by an individual. A platform is provided for initiating an objective pursuit. The platform is capable of allowing the individual to initiate the objective pursuit of the individual's choice. The system further includes a central server in communication with the first local computer. The central server is capable of creating a database for the objective pursuit. The central server includes a governance loop capable of taking permission from the individual to propagate the objective pursuit.

### CROSS-REFERENCE TO RELATED APPLICATIONS

This application is a non-provisional counterpart to and claims priority to U.S. Ser. No. 61/672,470 filed on Jul. 17, 2012 titled “SYSTEM AND METHOD FOR MANAGING ORGANIZATIONAL PARTICIPATION IN OBJECTIVE PURSUITS”, which is pending and which is hereby incorporated by reference for all purposes.

This application is a non-provisional counterpart to and claims priority to U.S. Ser. No. 61/696,183 filed on 2 Sep. 2012 titled “SYSTEM AND METHOD FOR MANAGING ORGANIZATIONAL PARTICIPATION IN OBJECTIVE PURSUITS”, which is pending and which is hereby incorporated by reference for all purposes.

### BACKGROUND OF THE INVENTION

1. Field of the Invention

The present invention is directed to a system and a method for managing organizational participation in an objective pursuit. More particularly the present invention is directed to a system and a method for managing organizational participation in objective pursuits by taking informed decisions based on individual poll or individual inputs from a group of individuals in the matter of the objective pursuit.

2. Discussion of the Related Art

Typically in any matter where a decision is to be made, individuals are involved; either when the individual is making a decision or a decision is being made on behalf of the individual. Invariably individuals making their decisions in the matter of organized pursuits feed from the vetted decisions of other individuals or their ecosystem if such information is available instead of researching anew. However in organizations as in companies, institutions, etc., traditional methods of organized pursuits are designed around large groups of individuals electing or selecting smaller groups of representatives and office bearers who take day to day decisions on behalf of all members of the organization. The basic merit of such a work structure is in the premise that it is not practical to poll or take inputs or opinions from all individual or constituent members, hence a representative model serves as an efficient proxy to run everyday business of large groups and public life. This work structure has a well-known and documented disadvantage of missing out on the collective opinion and wisdom of the individuals and learning from it as we design and execute public and large group policies and processes. Yet another method of polling may include a pre-mediated method where a questionnaire or a check-list may be provided and the individuals provide their inputs accordingly.

The technique involving statistical sampling based surveys may render a majority opinion but may leave the voices of the minority unheard just by sheer strength of the bargaining capacity of the majority “or due to sub-standard, incorrect, or incomplete sampling. The technique involving the representatives may include the prejudice and notions of the representatives in addition to that of the individuals and hence the inputs may be skewed. The technique involving the questionnaire or checklist may though provide inputs from every individual in a large group of individuals is based on tailor made set of questions and hence the resultant opinion does not arise out of the free will of the individuals. The disadvantages may often be corrected by using statistical sampling based surveys that give a sense on what constituents really want and how representative are the decisions taken by the organization, but it is apparent this sampling is also not based on input from all the individuals.

However, as individuals and groups become more and more interconnected, our problems acquire widespread national and international proportions in shorter and shorter intervals of time. As they touch individuals and groups from different cultures, with different challenges and with different priorities, our problems become more complex. The methods of obtaining inputs described hereinabove appear to be fast tending to being an obsolete practice as they are unable to keep abreast of the rising complexities resulting in delays in decision making.

Thus there is a need for an improved system and method for assisting organizations in taking informed decisions for organized pursuits based on the inputs of all the individuals in the group irrespective of the number of individuals in the group.

### SUMMARY OF INVENTION

In one embodiment, is provided a system for managing organizational participation in an objective pursuit. The system comprises a first local computer operated by an individual. A platform is provided for initiating an objective pursuit. The platform is capable of allowing the individual to initiate the objective pursuit of the individual's choice. The system further comprises a central server in communication with the first local computer. The central server is capable of creating a database for the objective pursuit. The central server comprises a governance loop capable of taking permission from the individual to propagate the objective pursuit.

In another embodiment, is provided a system for managing organizational participation in an objective pursuit. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization. The central server is capable of sharing the information with the organisation after completing the governance loop with each individual of the group. The system further comprises a second local computer system in communication with the central server operated by or on behalf of the organization, wherein the platform is provided for the organization to participate in the objective pursuit.

In yet another embodiment, is provided a system for managing organizational participation in an objective pursuit. The system comprises a first local computer system operated by an individual, wherein a platform is provided for initiating an objective pursuit, wherein the platform is capable of allowing the individual to initiate the objective pursuit of the individual's choice. The system further comprise a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of ascertaining information that an organization is supporting this objective pursuit and that the individual is connected with the organization. The central server is capable of informing the individual of the involvement of the organization in the objective pursuit. The system further comprises a second local computer system in communication with the central server operated by or on behalf of the organization, wherein the platform is provided for the organization and individual to participate together in the objective pursuit.

In yet another embodiment, is provided a system for managing organizational participation in an objective pursuit. The system comprises a first local computer system operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The system further comprises a second local computer system in communication with the central server operated by or on behalf of the organization, wherein the platform is provided for the organization to participate in the objective pursuit.

In still yet another embodiment, is provided a system for managing organizational participation in an objective pursuit. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The system further comprises a second local computer in communication with the central server operated by or on behalf of the organization, wherein the platform is provided for the organization to participate in the objective pursuit.

In still yet another embodiment, is provided a system for managing organizational participation in an objective pursuit. The system comprises a first local computer system operated by an individual, wherein a platform is provided for initiating an objective pursuit, wherein the platform is capable of allowing the individual to initiate the objective pursuit of the individual's choice. The system further comprise a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The system further comprises a second local computer operated by or on behalf of an organization, wherein the platform is provided for the organization to evaluate the database for objective pursuits. The organization elects to support at least one objective pursuit from the database for the objective pursuits. The central server is capable of informing the individual of the organization's election of supporting the objective pursuit. The central server reinitiates the governance loop to enable the individual to either accept or decline the organization's support. The individual accepts or declines the organization's support using the first local computer system operated by the individual.

In still yet another embodiment, is provided a method for managing organizational participation in an objective pursuit. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer, the central server having a verification loop to verify the credentials of the individual, wherein the central server is capable of creating a database for the objective pursuit. The central server includes a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The method further comprises a step of providing a second local computer in communication with the central server to be operated by or on behalf of the organization, wherein the platform is provided for the organization to participate in the objective pursuit.

In still yet another embodiment, is provided a method for managing organizational participation in an objective pursuit. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer, the central server having a verification loop to verify the credentials of the individual, wherein the central server is capable of creating a database for the objective pursuit. The central server having a governance loop capable of taking permission from the individual to propagate the objective pursuit. The central server is capable of ascertaining information that an organization is supporting this objective pursuit and that the individual is connected with the organization. The central server is capable of informing the individual of the involvement of the organization in the objective pursuit. The method further comprises a step of providing a second local computer operated by or on behalf of the organization, wherein the platform is provided for the organization and individual to participate together in the objective pursuit.

In still yet another embodiment, is provided a method for managing organizational participation in an objective pursuit. The method includes a step of providing a first local computer operated by an individual, wherein a platform is provided for initiating an objective pursuit, wherein the platform is capable of allowing the individual to initiate the objective pursuit of the individual's choice. The method further includes a next step of providing a central server in communication with the first local computer, the central server having a verification loop to verify the credentials of the individual, wherein the central server is capable of creating a database for the objective pursuit. The central server having a governance loop capable of taking permission from the individual to propagate the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The method further comprise a step of providing a second local computer in communication with the central server operated by or on behalf of the organization, wherein a platform is provided for the organization to participate in the objective pursuit.

In still yet another embodiment, is provided a method for managing organizational participation in an objective pursuit. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The method further comprises a step of providing a second local computer in communication with the central server to be operated by or on behalf of the organization, wherein the platform is provided for the organization to participate in the objective pursuit.

In still yet another embodiment, is provided a method for managing organizational participation in an objective pursuit. The method includes a step of providing a first local computer system to be operated by an individual, wherein a platform is provided for initiating an objective pursuit, wherein the platform is capable of allowing the individual to initiate the objective pursuit of the individual's choice. In a next step the method provides a central server in communication with the first local computer system, the central server having a verification loop to verify the credentials of the individual, wherein the central server is capable for creating a database for the objective pursuit. The central server having a governance loop capable of taking permission from the individual to propagate the objective pursuit. In a next step the method provides a second local computer operated by or on behalf of an organization, wherein the platform is provided for the organization to evaluate the database for objective pursuits. The organization elects to support at least one objective pursuit from the database for the objective pursuits. The central server is capable of informing the individual of the organization's election of supporting the objective pursuit. The central server reinitiates the governance loop to enable the individual to either accept or decline the organization's support. The individual accepts or declines the organization's support using the first local computer system operated by the individual.

By employing the above disclosed system and method processes may be designed and built with the assumption that it may be possible to poll all individuals of any organized group, no matter how large, on any issue, no matter how small, as long as the group may deem it valuable.

### BRIEF DESCRIPTION OF FIGURES

FIG. 1 is a schematic illustration representing a system for managing organizational participation in an objective pursuit in accordance with embodiments of the present disclosure.

FIG. 2 is a schematic illustration representing a system for managing organizational participation in an objective pursuit in accordance with embodiments of the present disclosure.

FIG. 3 is a schematic illustration representing a portion of a system for managing organizational participation in an objective pursuit in accordance with embodiments of the present disclosure.

FIG. 4 a schematic illustration representing a portion of a system for managing organizational participation in an objective pursuit in accordance with embodiments of the present disclosure.

FIG. 5 is a schematic illustration representing a portion of a system for managing organizational participation in an objective pursuit in accordance with embodiments of the present disclosure.

### DETAILED DESCRIPTION OF THE INVENTION

Embodiments of the invention as disclosed herein provide an improved system and method for managing organizational participation in an objective pursuit. As individuals and groups become more and more interconnected, our problems acquire widespread national and international proportions in shorter and shorter intervals of time. As they touch individuals and groups from different cultures, with different challenges and with different priorities, our problems become more complex. The representative approach of governance and problem solving is clearly not able to keep pace with this complexity and speed. However the same interconnectedness of individuals and technologies that enable this now offer us an opportunity to build next generation of solutions.

With the advent of internet and networking sites, many systems and methods are available and are proposed where individuals can share their inputs on their objective pursuits. However, since developments in technologies that enable interconnectedness are relatively recent, prior attempts of connecting individuals with similar objective pursuits have become possible only in past year or so. Developments in technologies of online social networking including blogging, crowd sourcing are in their early stages, and adoption of these developments are largely by individuals and that too for basic needs like staying in touch with friends and family, chatting online and sharing pictures, videos, etc. Adoption of these by organizations and institutions is in very early stages. Most organizations use these technologies for product promotions, online listening, and internal online chatting among others. The companies that offer online social communities appear to largely target individuals and not organizations.

A primary advantage and function of the system and method disclosed herein is the ability to poll or take inputs or opinions from each member of a group of individuals before taking a decision to participate in an objective pursuit irrespective of the size of the group. In various embodiments, the system and method disclosed herein do so by taking concurrence from the individuals before propagating the objective pursuit to other individuals or to organizations and then taking concurrence from each such individual before propagating to still more individuals and organizations. The system and method serve to bring together individuals or groups of individuals and organizations that may be otherwise following the same objective pursuit regardless of the others' participation thus making it beneficial for the organization, individual, and the objective pursuit.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed. Terms such as “first,” “second,” and other numerical terms when used herein do not imply a sequence or order unless clearly indicated by the context. Thus, a first step or computer discussed below could be termed a second step or computer without departing from the teachings of the exemplary embodiments.

In various embodiments, the individual who initiates the objective pursuit may be referred to as a “creator”, the individual or group of individuals who then supports the objective pursuit may be referred to as a “supporter”, and the organization that elects to support the objective pursuit may be referred to as a “sponsor”. As used herein the phrase “objective pursuit” may alternatively be referred to as a “cause” in the specification.

In one embodiment, is provided a system for managing organizational participation in an objective pursuit. The system comprises a first local computer operated by an individual. A platform is provided for initiating an objective pursuit. The platform is capable of allowing the individual to initiate the objective pursuit of the individual's choice. The system further comprises a central server in communication with the first local computer. The central server is capable of creating a database for the objective pursuit. The central server comprises a governance loop capable of taking permission from the individual to propagate the objective pursuit.

In another embodiment, is provided a system for managing organizational participation in an objective pursuit. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The system further comprises a second local computer system in communication with the central server operated by or on behalf of the organization, wherein the platform is provided for the organization to participate in the objective pursuit.

In yet another embodiment, is provided a system for managing organizational participation in an objective pursuit. The system comprises a first local computer system operated by an individual, wherein a platform is provided for initiating an objective pursuit, wherein the platform is capable of allowing the individual to initiate the objective pursuit of the individual's choice. The system further comprise a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of ascertaining information that an organization is supporting this objective pursuit and that the individual is connected with the organization. The central server is capable of informing the individual of the involvement of the organization in the objective pursuit. The system further comprises a second local computer system in communication with the central server operated by or on behalf of the organization, wherein the platform is provided for the organization and individual to participate together in the objective pursuit.

In yet another embodiment is provided a system for managing organizational participation in an objective pursuit. The system comprises a first local computer system operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The system further comprises a second local computer system in communication with the central server operated by or on behalf of the organization, wherein the platform is provided for the organization to participate in the objective pursuit.

In still yet another embodiment, is provided a system for managing organizational participation in an objective pursuit. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The system further comprises a second local computer in communication with the central server operated by or on behalf of the organization, wherein the platform is provided for the organization to participate in the objective pursuit.

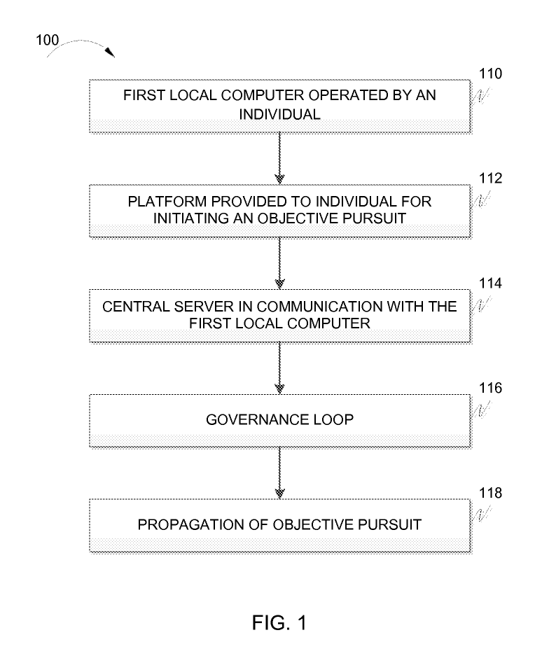

Referring to FIG. 1, a schematic illustration representing a system 100 for managing organizational participation in an objective pursuit in accordance with embodiments of the present disclosure is provided. The system 100 includes a first local computer operated by an individual 110. A platform is provided to the individual for initiating an objective pursuit 112 of the individual's choice. As used herein the phrase “individual's choice” means that there is no fixed list of objective pursuits or causes that an individual has to choose from. The individual has the flexibility to include an objective pursuit of the individual's choice. In one embodiment, the platform provided includes any suitable platform considered useful for this purpose by a person skilled in the art. Suitable examples of platforms may include but may not be limited to Facebook and LinkedIn. In one embodiment, the individual may be required to provide a title for the objective pursuit, a story or explanation on the objective pursuit, and optionally a photograph or photographs relevant to the objective pursuit. In certain other embodiments, the system may require the individual to provide other details as may be required from time to time to authenticate the information provided. The system further comprises a central server 114. In one embodiment, the central server is in communication with the first local computer. A person skilled in the art may determine the type of server that may be used as the central server, and the type of computer that may be employed as the local computer. The central server includes a governance loop 116. Using the governance loop the central server is capable of taking permission from the individual who initiates the objective pursuit to propagate the objective pursuit 118.

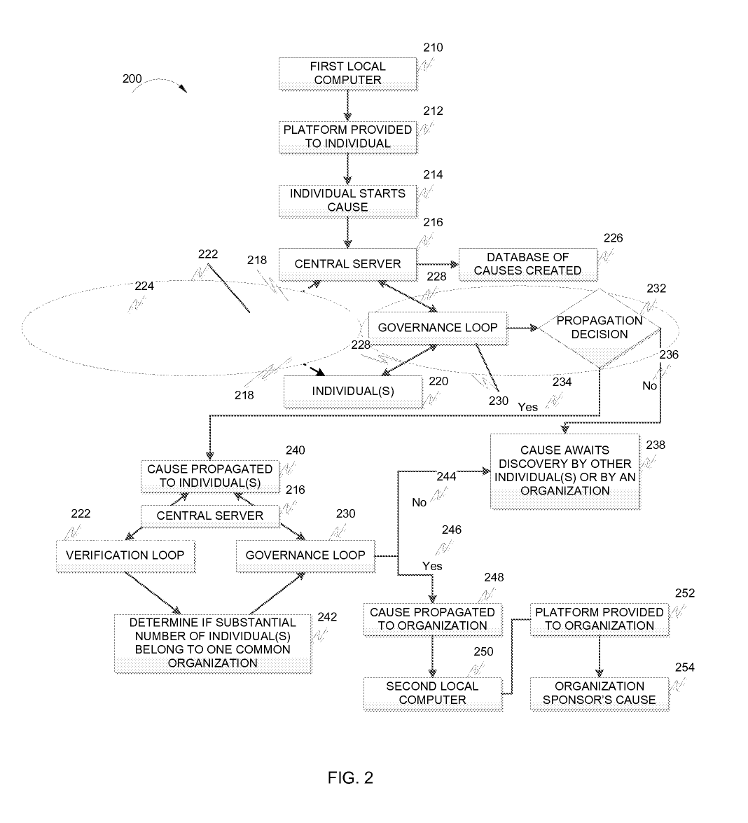

Referring to FIG. 2, a schematic illustration representing a system 200 for managing organizational participation in an objective pursuit in accordance with embodiments of the present disclosure is provided. The system 200 provides a first local computer 210. An individual 220 may use the first local computer 210 to access a platform provided to the individual 212. The individual can start 214 an objective pursuit i.e., a cause as referred to in FIG. 2 by using the platform 212 and the first local computer 210. A central server 216 is provided. The central server 216 is in communication with the first local computer 210. In one embodiment, once the individual initiates the cause the central server 216 initiates a to and fro communication 218 with the individual 220 using the first local computer 210. The to and fro communication 218 initiates an optional verification loop 222 to verify the credentials 224 of the individual 220. Once the credentials 224 are verified the central server 216 creates a database 226 of the causes or includes the cause in an existing database. In one embodiment, once the database is created the central server 216 initiates a to and fro communication 228 with the individual 220 using the first local computer 210. The to and fro communication 228 initiates a governance loop 230. The governance loop 230 gives the individual 220 an opportunity to make a propagation decision 232. If the individual 220 gives a negative indication 236 i.e.; “NO”, then the cause remains in the database 226 waiting to be discovered by others who may browse through the database. If the individual provides a negative indication 236 the system 200 does not actively attempt to propagate the cause to other individuals available in the social network of the individual 220 who created the cause. The cause may remain on the database waiting for others to discover it. On the other hand if the individual 220 gives a positive indication 234 the cause may be actively propagated by the central server 216 to a group of other individuals 240. The other individuals in their turn use a local computer or other suitable mechanism (not shown in figure) to support the cause and thus become supporters of the cause. In one embodiment, the central server 216 may allow the other individuals 240 to support the cause only after initiating and completing a verification loop 222 with each member in the group of other individuals. Once the verification loop 222 is completed the central server may ascertain information i.e., determine if a substantial number of individuals belong to one organization 242. The central server 216 initiating the governance loop 230 with each of the other individuals in the group of other individuals 240. For each individual of the group who gives a negative indication 244, the cause stays in the database created 238 waiting to be discovered. In one embodiment, for each individual of the group who gives a positive indication 246 the cause may be further propagated to other individuals in the social network of each of these individuals (not shown in figure). In another embodiment, for each individual of the group who gives a positive indication 246, and if it is determined that a substantial number of the individuals belong to one organization 242, then the cause is propagated to such organization 248. The organization 248 may use a second local computer 250 and use a platform provided 252 and support or sponsor the cause 254. Thus there is no automatic or self, propagation of the cause once the cause is created without initiating the governance loop and taking permission from the creator and subsequently the supporters. In certain embodiments, (not shown in figure), if an individual starts a cause the central server may determine after having followed the verification loop that the individual belongs to an organization that supports the cause. The central server may then initiate the governance loop with the individual and seek permission from the individual to take organizational support for this cause. In one embodiment, if the individual gives a negative indication then the central server will not proceed with informing the individual of the organization's participation in the cause. In another embodiment, if the individual gives a positive indication then the central server will proceed with informing the individual of the organization's participation. The individual and the organization may then use their local computers and their platforms to together participate in the cause.

In one embodiment, the individual who creates the cause may also be provided with a platform that allows the individual to choose the kind of support the individual expects from peers. For example, the individual may choose any one of the following support from peers i.e., be a volunteer, pledge fund, sign a petition, or simply vote for the cause. The individual is also provided with an option to classify or bucket the cause, i.e., the individual may classify the cause under human rights, education, etc.

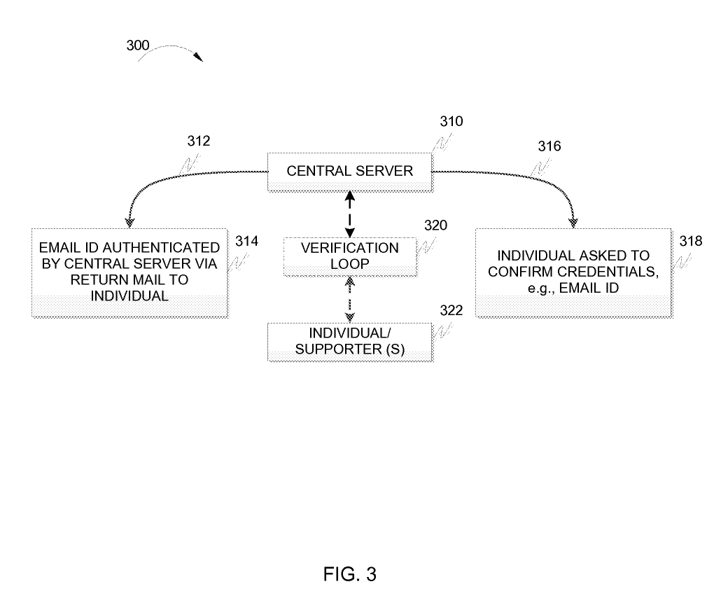

Referring to FIG. 3, a schematic illustration representing a portion 300 of system for managing organizational participation in an objective pursuit in accordance with embodiments of the present disclosure is provided. The portion 300 shows the verification loop initiated by the central server 310 to verify every individual 322 who creates or supports a cause. The central server 310 may initiate a verification loop 320. The verification loop 320 includes a first step 312 of the central server 310 sending a return electronic mail 314 to the individual. This is to verify the authenticity of the individual's electronic mail information and other credentials provided by the individual 322 while creating or supporting the cause. The verification message may request 316 the individual to confirm 318 their electronic mail identification and other credentials by responding to the return electronic mail. In one embodiment, the central server may require the individual to provide an official electronic mail identification as one of the purposes of this invention is to assist an organization to employ the social discovery process before sponsoring any objective pursuit.

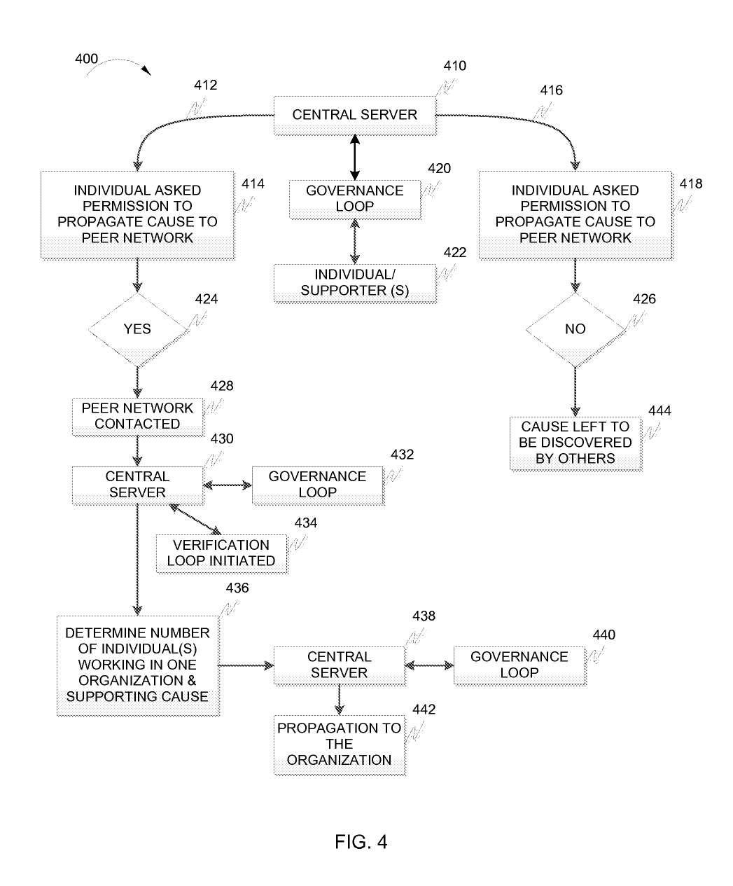

Referring to FIG. 4, a schematic illustration representing a portion 400 of system for managing organizational participation in an objective pursuit in accordance with embodiments of the present disclosure is provided. In one embodiment, the portion 400 shows the governance 420 loop initiated by the central server 410 to take permission 412 from very individual who creates 422 a cause to propagate the cause to other individuals in the peer network 414 or social network of the individual. This individual may be called as the creator of the cause or objective pursuit. If a positive indication 424 i.e., “YES”, is obtained from the individual then the peer network is contacted and the database formed by the central server (not shown in figure, as discussed herein above) is made viewable to the peer network. The central server 430 now communicates with each individual from the peer network and initiates the verification loop 434 as discussed in FIG. 3 and the governance loop 432 as discussed in FIG. 4. The verification loop 434 verifies the credentials of each individual from the peer network. During the verification procedure the central server may accept the non-official electronic mail identification of the individual. The governance loop 432 is initiated to take permission from each individual from the peer network to propagate the cause to their peer network (not shown in figure). While proceeding with the governance loop the central server may require the individual to provide official electronic mail identification as this information is then later used to determine the number of individuals that belong to one common organization and are supporting one common objective pursuit as described herein below. The verification loop and governance loop is thus initiated not only with the creator of the cause but also with each individual who supports the cause. In another embodiment, the central server analyses the electronic mail identification (i.e. official electronic mail identification) provided by individuals as a result of the verification loop and determines 436 that a substantial number of the individuals are working in one common organization. In one embodiment, the creator and supporter may belong to the same organization. In another embodiment, the creator and supporter may belong to different organizations. The central server 438 again initiates the governance loop 440 with each individual and requests permission to propagate the cause to the organization 442. Thus the current disclosure is advantageous in that at each step every individual involved either in the role of a creator or a supporter is given an option to provide permission for further propagation of the cause. Accordingly, an organization derives benefits from a combined vote or poll of each individual who is a part of the cause and not just from a majority number of individuals who may be part of the cause.

In still yet another embodiment, is provided a system for managing organizational participation in an objective pursuit. The system comprises a first local computer operated by an individual, wherein a platform is provided for initiating an objective pursuit, wherein the platform is capable of allowing the individual to initiate the objective pursuit of the individual's choice. The system further comprises a central server in communication with the first local computer system, the central server having a verification loop to verify the credentials of the individual, wherein the central server is capable for creating a database for the objective pursuit. The central server has a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The system further comprises a second local computer in communication with the central server operated by or on behalf of the organization, wherein the platform is provided for the organization to participate in the objective pursuit.

In still yet another embodiment, is provided a system for managing organizational participation in an objective pursuit. The system comprises a first local computer system operated by an individual, wherein a platform is provided for initiating an objective pursuit, wherein the platform is capable of allowing the individual to initiate the objective pursuit of the individual's choice. The system further comprise a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The system further comprises a second local computer operated by or on behalf of an organization, wherein the platform is provided for the organization to evaluate the database for objective pursuits. The organization elects to support at least one objective pursuit from the database for the objective pursuits. The central server is capable of informing the individual of the organization's election of supporting the objective pursuit. The central server reinitiates the governance loop to enable the individual to either accept or decline the organization's support. The individual accepts or declines the organization's support using the first local computer system operated by the individual.

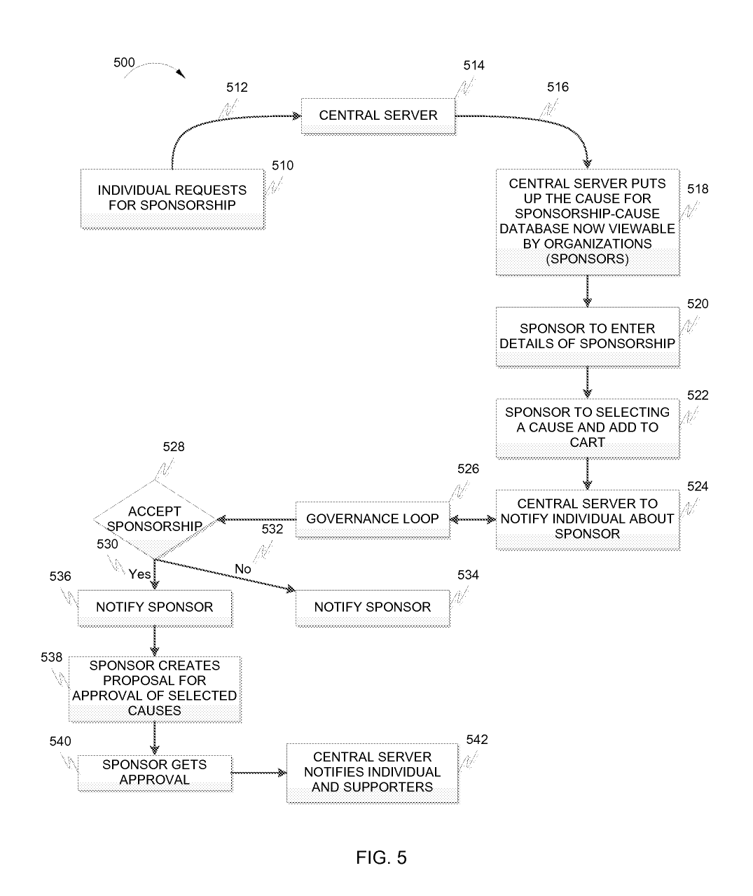

Referring to FIG. 5, a schematic illustration representing a portion 500 of a system for managing organizational participation in an objective pursuit in accordance with embodiments of the present disclosure is provided. In the platform (discussed herein above, not shown in FIG. 5) an individual is given an option to request sponsorship 510 for a cause. The request is forwarded 512 to the central server 514. The central server 512 opens up the cause 516 for sponsorship and the cause database is then rendered viewable by organizations 518. The organization is then provided a platform to enter details of the sponsorship 520 in a second local computer (not shown in figure). In various embodiments the details may include the story behind why the organization would like to sponsor the cause, if the organization is sponsoring any such similar cause, if the organization is aware that any of their employee supports the cause, and the like. The organization then selects the cause and adds to a cart 522. The central server then initiates a governance loop 526 by notifying the individual who created the cause about the organization 524. The individual is then provided with a decision box 528 on whether to provide a positive indication or negative indication to the sponsorship. If the individual provides a negative indication 532 the organization is notified 534 and the cause is not propagated any father by the central server to the organization in question. IF the individual provides a positive indication 530, the organization is notified 536. The organization may then create a proposal to get approval for the cause 538 and get approval for sponsoring the cause 540. The creator and supporters are then notified about the approval 542. The creator may be provided the rights to make a final approval using decision box 528, though each supporter may be provided with a right to give an approval. For example, if the cause is in favour of “No Smoking” the creator may provide a negative indication to accept support from an organization manufacturing cigarettes. However one of the supporter may provide a positive indication for accepting sponsorship. In this example, the creator's decision holds more power than that of the supporter and the organization is notified that the sponsorship has been rejected by the creator.

In still yet another embodiment, is provided a method for managing organizational participation in an objective pursuit. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer, the central server having a verification loop to verify the credentials of the individual, wherein the central server is capable of creating a database for the objective pursuit. The central server includes a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The method further comprises a step of providing a second local computer in communication with the central server to be operated by or on behalf of the organization, wherein the platform is provided for the organization to participate in the objective pursuit.

In still yet another embodiment, is provided a method for managing organizational participation in an objective pursuit. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer, the central server having a verification loop to verify the credentials of the individual, wherein the central server is capable of creating a database for the objective pursuit. The central server having a governance loop capable of taking permission from the individual to propagate the objective pursuit. The central server is capable of ascertaining information that an organization is supporting this objective pursuit and that the individual is connected with the organization. The central server is capable of informing the individual of the involvement of the organization in the objective pursuit. The method further comprises a step of providing a second local computer operated by or on behalf of the organization, wherein the platform is provided for the organization and individual to participate together in the objective pursuit.

In still yet another embodiment, is provided a method for managing organizational participation in an objective pursuit. The method includes a step of providing a first local computer operated by an individual, wherein a platform is provided for initiating an objective pursuit, wherein the platform is capable of allowing the individual to initiate the objective pursuit of the individual's choice. The method further includes a next step of providing a central server in communication with the first local computer, the central server having a verification loop to verify the credentials of the individual, wherein the central server is capable of creating a database for the objective pursuit. The central server having a governance loop capable of taking permission from the individual to propagate the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The method further comprise a step of providing a second local computer in communication with the central server operated by or on behalf of the organization, wherein a platform is provided for the organization to participate in the objective pursuit.

In still yet another embodiment, is provided a method for managing organizational participation in an objective pursuit. The method includes a step of providing a first local computer to be operated by an individual, wherein a platform is provided for initiating an objective pursuit, wherein the platform is capable of allowing the individual to initiate the objective pursuit of the individual's choice. In a next step the method provides a central server in communication with the first local computer system, the central server having a verification loop to verify the credentials of the individual, wherein the central server is capable for creating a database for the objective pursuit. The central server includes a governance loop capable of taking permission from the individual to propagate the objective pursuit. The central server is capable of propagating the objective pursuit to a larger population of individuals, each time initiating the verification loop and the governance loop with each individual supporting the objective pursuit. The central server is capable of ascertaining information that a group consisting of a substantial number of individuals supporting the objective pursuit is working in one common organization, wherein the central server is capable of sharing the information with the organisation after completing the governance loop with each individual of the group. The individual and the group of individuals are working in the same organization or in different organizations. The method further comprises a step of providing a second local computer in communication with the central server to be operated by or on behalf of the organization, wherein the platform is provided for the organization to participate in the objective pursuit.

In still yet another embodiment, is provided a method for managing organizational participation in an objective pursuit. The method includes a step of providing a first local computer system to be operated by an individual, wherein a platform is provided for initiating an objective pursuit, wherein the platform is capable of allowing the individual to initiate the objective pursuit of the individual's choice. In a next step the method provides a central server in communication with the first local computer system, the central server having a verification loop to verify the credentials of the individual, wherein the central server is capable for creating a database for the objective pursuit. The central server having a governance loop capable of taking permission from the individual to propagate the objective pursuit. In a next step the method provides a second local computer operated by or on behalf of an organization, wherein the platform is provided for the organization to evaluate the database for objective pursuits. The organization elects to support at least one objective pursuit from the database for the objective pursuits. The central server is capable of informing the individual of the organization's election of supporting the objective pursuit. The central server reinitiates the governance loop to enable the individual to either accept or decline the organization's support. The individual accepts or declines the organization's support using the first local computer system operated by the individual.

Suitable examples of objective pursuits may include but are not limited to social causes, subject matter related to policy making, information sharing, recruitment, referral of employees, and maintaining employee satisfaction. For example, let us consider an online social networking based system. The system allows corporations and institutions to connect with an individual's passion for social and environmental causes through a social discovery method. As used herein, the phrase “social discovery method” refers to the age old method of checking with relatives, friends, acquaintances and reliable sources before taking any decision, for example donating for a tsunami cause. Organizations in their turn feed off the information available with their employees who participate in such social and environmental causes. Organizations can then support these causes through a safe and socially verifiable method. The social discovery process and the socially verifiable support method are very powerful in solving several problems that we face in human organizations. Examples of such human organizations include but are not limited to communities, workplaces, schools, governments and not-for-profit organizations.

This presents a new paradigm in organization management and organization design that allows us to re-imagine and re-design several existing processes to better address the problems they attempt to solve. Also this holds the potential to design and develop entirely new organization processes that may be effective in solving some of our unsolved problems and those that of next generation complexity that are bound to surface in the future.

The technical advantage of a total polling approach over representative sampling approach may be apparent. Quality of data may be superior leading to better decisions. Acceptability of decisions by individuals or constituents may be better as everyone gets heard. Authenticity of decisions may be significantly higher than a representative approach as people take responsibility for decisions. Since a lot of polling can be passive and those that are active are permission based, we can avoid polling fatigue that may be a likely negative effect of such an approach.

Complete commercial advantages of this approach are less obvious. However, we have identified applications in the fields like employee citizenship and employee development that have found early acceptance with business corporations. We believe these concepts may be applied to Customer Citizenship and Micro Market Development in near to medium term. There can be several other applications in the long term.

The foregoing embodiments meet the overall objectives of this disclosure as summarized above. However, it will be clearly understood by those skilled in the art that the foregoing description has been made in terms only of the most preferred specific embodiments. Therefore, many other changes and modifications clearly and easily can be made that are also useful improvements and definitely outside the existing art without departing from the scope of the present disclosure, indeed which remain within its very broad overall scope, and which disclosure is to be defined over the existing art by the appended claims.

What is claimed is:

1. A system for managing organizational participation in an objective pursuit comprising:
a first local computer operated by an individual, wherein a platform is provided for initiating an objective pursuit, wherein the platform is capable of allowing the individual to initiate the objective pursuit of the individual's choice; and
a central server in communication with the first local computer, wherein the central server is capable of creating a database for the objective pursuit, and wherein the central server comprises a governance loop capable of taking permission from the individual to propagate the objective pursuit.

2. The system of claim 1, wherein the central server further comprises a verification loop, wherein the verification loop is capable of verifying the credentials of the individual initiating the objective pursuit.

3. The system of claim 1, wherein the platform requires the individual to provide information about the objective pursuit.

4. The system of claim 1, wherein the information comprises a classification of the objective pursuit.

5. The system of claim 1, wherein the governance loop is capable of taking permission from the individual to propagate the objective pursuit with at least one other individual.

6. The system of claim 5, wherein the individual is provided a platform to provide information on the type of support expected from the at least one other individual.

7. The system of claim 1, wherein the governance loop is capable of taking permission from the individual to propagate the objective pursuit with at least one organization.

8. The system of claim 1, wherein the central server is capable of propagating the objective pursuit to a larger population of individuals, each time initiating the verification loop and the governance loop with each individual supporting the objective pursuit.

9. The system of claim 1, wherein the central server is capable of ascertaining information that a group consisting of a substantial number of individuals supporting the objective pursuit is working in one common organization.

10. The system of claim 9, wherein the central server is capable of sharing the information with the organisation after completing the governance loop with each individual of the group.

11. The system of claim 1, further comprising a second local computer operated by or on behalf of the organization, wherein the platform is provided for the organization to participate in the objective pursuit.

12. A system for managing organizational participation in an objective pursuit comprising:
a first local computer operated by an individual, wherein a platform is provided for initiating an objective pursuit, wherein the platform is capable of allowing the individual to initiate the objective pursuit of the individual's choice;
a central server in communication with the first local computer system, the central server having a verification loop to verify the credentials of the individual, wherein the central server is capable for creating a database for the objective pursuit;
the central server having a governance loop capable of taking permission from the individual to propagate the objective pursuit;
wherein the central server is capable of propagating the objective pursuit to a larger population of individuals, each time initiating the verification loop and the governance loop with each individual supporting the objective pursuit; and
wherein the central server is capable of ascertaining information that a group consisting of a substantial number of individuals supporting the objective pursuit is working in one common organization, wherein the central server is capable of sharing the information with the organisation after completing the governance loop with each individual of the group; and
a second local computer system operated by or on behalf of the organization, wherein the platform is provided for the organization to participate in the objective pursuit.

13. A system for managing organizational participation in an objective pursuit comprising:
a first local computer system operated by an individual, wherein a platform is provided for initiating an objective pursuit, wherein the platform is capable of allowing the individual to initiate the objective pursuit of the individual's choice;
a central server in communication with the first local computer system, the central server having a verification loop to verify the credentials of the individual, wherein the central server is capable for creating a database for the objective pursuit;
the central server having a governance loop capable of taking permission from the individual to propagate the objective pursuit;
wherein the central server is capable of ascertaining information that an organization is supporting this objective pursuit and that the individual is connected with the organization; wherein the central server is capable of informing the individual of the involvement of the organization in the objective pursuit; and
a second local computer system operated by or on behalf of the organization, wherein the platform is provided for the organization and individual to participate together in the objective pursuit.

14. A system for managing organizational participation in an objective pursuit comprising:
a first local computer system operated by an individual, wherein a platform is provided for initiating an objective pursuit, wherein the platform is capable of allowing the individual to initiate the objective pursuit of the individual's choice;
a central server in communication with the first local computer system, the central server having a verification loop to verify the credentials of the individual, wherein the central server is capable for creating a database for the objective pursuit;
the central server having a governance loop capable of taking permission from the individual to propagate the objective pursuit; and
wherein the central server is capable of ascertaining information that a group consisting of a substantial number of individuals supporting the objective pursuit is working in one common organization, wherein the central server is capable of sharing the information with the organisation after completing the governance loop with each individual of the group; and
a second local computer system operated by or on behalf of the organization, wherein the platform is provided for the organization to participate in the objective pursuit.

15. A system for managing organizational participation in an objective pursuit comprising:
a first local computer operated by an individual, wherein a platform is provided for initiating an objective pursuit, wherein the platform is capable of allowing the individual to initiate the objective pursuit of the individual's choice;
a central server in communication with the first local computer system, the central server having a verification loop to verify the credentials of the individual, wherein the central server is capable of creating a database for the objective pursuit;
the central server having a governance loop capable of taking permission from the individual to propagate the objective pursuit;
wherein the central server is capable of propagating the objective pursuit to a larger population of individuals, each time initiating the verification loop and the governance loop with each individual supporting the objective pursuit;
wherein the central server is capable of ascertaining information that a group consisting of a substantial number of individuals supporting the objective pursuit is working in one common organization, wherein the central server is capable of sharing the information with the organisation after completing the governance loop with each individual of the group;
wherein the individual and the group of individuals are working in the same organization or in different organizations; and
a second local computer operated by or on behalf of the organization, wherein the platform is provided for the organization to participate in the objective pursuit.

16. A system for managing organizational participation in an objective pursuit comprising:
a first local computer system operated by an individual, wherein a platform is provided for initiating an objective pursuit, wherein the platform is capable of allowing the individual to initiate the objective pursuit of the individual's choice;
a central server in communication with the first local computer system, the central server having a verification loop to verify the credentials of the individual, wherein the central server is capable for creating a database for objective pursuits;
the central server having a governance loop capable of taking permission from the individual to propagate the objective pursuit;
a second local computer operated by or on behalf of an organization, wherein the platform is provided for the organization to evaluate the database for objective pursuits;
wherein the organization elects to support at least one objective pursuit from the database for the objective pursuits;
wherein the central server is capable of informing the individual of the organization's election of supporting the objective pursuit;
wherein the central server reinitiates the governance loop to enable the individual to either accept or decline the organization's support; and
wherein the individual accepts or declines the organization's support using the first local computer system operated by the individual.
